(19) United States
(12) Patent Application Publication
(10) Pub. No.: US 2014/0257990 A1
(43) Pub. Date: Sep. 11, 2014

(54) METHOD AND SYSTEM FOR DETERMINING CORRELATIONS BETWEEN PERSONALITY TRAITS OF A GROUP OF CONSUMERS AND A BRAND/PRODUCT

(71) Applicant: TipTap, Inc., Cambridge, MA (US)

(72) Inventors: Daniel Cudgma, Needham, MA (US); Christopher C. Nocera, Westerly, RI (US); Kyle A. Thomas, Cambridge, MA (US)

(73) Assignee: TipTap, Inc., Cambridge, MA (US)

(21) Appl. No.: 14/190,407

(22) Filed: Feb. 26, 2014

Related U.S. Application Data
(60) Provisional application No. 61/773,567, filed on Mar. 6, 2013.

(51) Int. Cl. G06Q 30/02

(52) U.S. Cl. CPC G06Q 30/0269
USPC 705/14.66

(57) ABSTRACT

A computer implemented system and method determines correlations between one or more personality traits of a group of consumers and one or more brand/product. A first collection of consumer motivations of the group of consumers are determined based on associations between possible consumer motivations and the one or more personality traits. A second collection of consumer motivations are derived from the first collection of consumer motivations, where each consumer motivation of the second collection has a correlation with the one or more brand/product. Correlations between the personality traits and the brand/product are determined and output by identifying which of the one or more personality traits contributed to each of the consumer motivations of the second collection based on the associations between the possible consumer motivations and the one or more personality traits from the group of consumers.

### RELATED APPLICATION

This application claims priority to, and the benefit of, co-pending U.S. Provisional Application No. 61/773,567 filed Mar. 6, 2013, for all subject matter common to both applications. The disclosure of said provisional application is hereby incorporated by reference in its entirety.

### FIELD OF THE INVENTION

The present invention relates to marketing surveys suitable for providing information about a consumer. More particularly, the present invention relates to computer-implemented systems and methods for determining correlations between personality traits of consumers and one or more brand/product.

### BACKGROUND

There are a number of marketing technologies or techniques being used in academic research and within the marketing industry. These techniques include established research methods in social and personality psychology (and other social sciences). Many marketing technologies or techniques are adapted from these various psychological research methods.

The field of understanding consumer motivations is vast, incorporating everything from consumer surveys routinely used by companies, to functional magnetic resonance (fMRI) scans used by “neuromarketing” companies, to “psychographics” approaches to market segmentation.

For example, some research being performed by “neuromarketing” companies is focused on “psychographics”. In particular, these companies are trying to use psychographics with respect to market segmentation and advertising. However, current marketing research has not been able to adequately address or solve the issue of understanding consumer motivations particularly tapping into these consumer motivations using psychological techniques.

### SUMMARY

Conventional marketing methods have not been able to adequately incorporate motivational analysis into determining the right marketing channels based on an understanding of consumer motivations. There is a need in the marketing field to obtain marketing information to determine whether a brand/product appeals to consumers with certain motivations (e.g., eco-consciousness and thrill-seeking). In addition, this information could be further used to determine where and how individuals with such motivations may be contacted.

There is a need to obtain better insight into the motivations people have that can be accessed through different marketing channels. For example, this insight can be obtained through surveys on TV viewing behavior to people with known psychological profiles. Thus, this obtained data could reveal different motivational profiles of people that view different TV shows. The present invention is directed toward further solutions to address this need, in addition to having other desirable characteristics.

In accordance with an embodiment of the present invention, a computer implemented method for determining correlations between personality traits of a group of consumers and one or more brand/product includes storing one or more personality traits for the group of consumers in at least one data store. Using at least one processor, a first collection of consumer motivations of the group of consumers are determined based on associations between possible consumer motivations and the one or more personality traits from the group of consumers. The first collection of consumer motivations is stored in at least one data store. Using at least one processor, a second collection of consumer motivations are derived from the first collection of consumer motivations. Each consumer motivation of the second collection has a correlation with the one or more brand/product. The second collection of consumer motivations is stored in at least one data store. Correlations between the one or more personality traits of the group of consumers and the one or more brand/product are determined by identifying which of the one or more personality traits contributed to each of the consumer motivations of the second collection based on the associations between the possible consumer motivations and the one or more personality traits from the group of consumers. The correlations between the one or more personality traits of the group of consumers and the one or more brand/product are outputted using an output device.

In accordance with an aspect of the present invention, the method further includes generating, using at least one processor, consumer motivational segments based on the one or more consumer motivations of the second collection.

In accordance with aspects of the present invention, the method further includes identifying, using at least one processor, a desired brand/product personality. In a further aspect, one or more consumer motivations of the second collection are identified, using at least one processor, as actually positively correlating with the desired brand/product personality.

In accordance with aspects of the present invention, one or more brand/product personality traits, brand/product characteristics, or combinations thereof are identified using at least one processor. In a further aspect, the identification of the brand/product personality traits, brand/product characteristics, or combinations thereof further includes providing a brand/product survey having questions related to dimensions of the brand/product personality traits, brand/product characteristics, or combinations thereof.

In accordance with aspects of the present invention, the identification of the brand/product personality traits, brand/product characteristics, or combinations thereof further includes using at least one processor to determine a brand/product personality striving index. In a further aspect, the brand/product personality striving index is determined based on response data from surveys directed to a respondent perceived brand/product market position and a respondent ideal brand/product market position.

In accordance with aspects of the present invention, the identification of the brand/product personality traits, brand/product characteristics, or combinations thereof further includes assessing, using at least one processor, the respondent ideal brand/product market position for potential consumers. In another aspect, the identification of the brand/product personality traits, brand/product characteristics, or combinations thereof further includes capturing, using at least one processor, areas of improvement based on the respondent perceived brand/product market position.

In accordance with aspects of the present invention, the brand/product personality traits, brand/product characteristics, or combinations thereof are used for aligning different individuals on a marketing team. In another aspect, the brand/product personality traits, brand/product characteristics, or combinations thereof are used for determining which consumer-facing components are out of alignment or could use improvement.

In accordance with aspects of the present invention, a trait survey is provided having questions related to one or more of: brand, product, and domain of interest. The trait survey identifies one or more personality traits for the group of consumers.

In accordance with aspects of the present invention, a series of scores is determined using at least one processor. The series of scores include a profile for each of the one or more personality traits for each consumer of the group of consumers based on survey answers to surveys completed by each consumer. In a further aspect, at least one processor is used to determine a psychological profile based on the series of scores. In another aspect, at least one processor is used to determine connections between a psychological profile and the series of scores by each consumer.

In accordance with an aspect of the present invention, the deriving of the second collection of consumer motivations is optimized and repeated for identifying additional consumer motivations.

In accordance with aspects of the present invention, the second collection of consumer motivations is refined using at least one processor. A specific understanding of the nature of the derived second collection of consumer motivations is identified using at least one processor.

In accordance with aspects of the present invention, the determination of the first collection of consumer motivations further includes providing an implicit cognition survey having questions related to one or more of: implicit associations, biases, and motivations. In another aspect, the determination of the first collection of consumer motivations further includes using at least one processor to determine implicit cognition measures for each consumer of the group of consumers based on survey answers to surveys completed by each consumer.

In accordance with aspects of the present invention, the method further includes identifying, using at least one processor, which of the consumer motivations of the second collection of consumer motivations correlate to each of the marketing channels. In a further aspect, the identification of consumer motivations that correlate to marketing channels includes providing a marketing channel identification survey to the group of consumers having questions related to participation in the marketing channels. In another aspect, the identification of consumer motivations that correlate to marketing channels includes using at least one processor to determine marketing channel identification data for each consumer of the group of consumers based on survey answers to surveys completed by each consumer.

In accordance with an embodiment of the present invention, a computer implemented system for determining correlations between personality traits of a group of consumers and one or more brand/product includes at least one data store, at least one processor, and at least one output device. The at least one data store is configured to store one or more personality traits for the group of consumers. The at least one processor is configured to determine a first collection of consumer motivations of the group of consumers based on associations between possible consumer motivations and the one or more personality traits from the group of consumers. The at least one data store is configured to store the first collection of consumer motivations. The at least one processor is configured to derive a second collection of consumer motivations from the first collection of consumer motivations such that each consumer motivation of the second collection has a correlation with one or more brand/product. The at least one data store is configured to store the second collection of consumer motivations. The at least one processor is configured to determine correlations between the one or more personality traits of the group of consumers and the one or more brand/product by identifying which of the one or more personality traits contributed to each of the consumer motivations of the second collection based on the associations between the possible consumer motivations and the one or more personality traits from the group of consumers. The output device is configured to output the correlations between the one or more personality traits of the group of consumers and the one or more brand/product.

### BRIEF DESCRIPTION OF THE FIGURES

These and other characteristics of the present invention will be more fully understood by reference to the following detailed description in conjunction with the attached drawings, in which:

FIG. 1 is a schematic diagram of a system for determining correlations between personality traits of a group of consumers and one or more brand/product, according to an embodiment of the present invention;

FIG. 2A is a flow chart diagram illustrating a method for determining correlations between personality traits of a group of consumers and one or more brand/product, according to one aspect of the present invention;

FIG. 2B is a flow chart diagram illustrating sub-steps within the step of completing a survey, according to one aspect of the present invention;

FIG. 2C is a flow chart diagram illustrating optional add-on analysis steps from the step of interpreting outputted data analysis, according to aspects of the present invention;

FIG. 3 is a bar graph illustrating an example of data output from the system of FIG. 1 and/or method of FIG. 2A, according to one aspect of the present invention; and

FIG. 4 is a schematic diagram illustrating an example computing device for implementing embodiments of the present invention.

### DETAILED DESCRIPTION

An illustrative embodiment of the present invention relates to a computer implemented system and method for determining correlations between personality traits of a group of consumers and one or more brand and/or product (hereinafter “brand/product”). In particular, the present invention system and method is directed to providing an understanding of motivations behind consumer behavior and brand/product affiliation. The present invention system and method is directed to employing established psychological research techniques in a specific process in order to uncover consumer motivations with respect to personality traits.

It is often difficult to determine why consumers make the decisions that they do and what draws them to certain brands or products. The present invention can be used to obtain this information. In particular, the present invention system/method is directed to uncovering motivations behind purchasing behavior and brand/product affiliation. This can be used to gain useful insight on all aspects of branding and marketing, including, but not limited to: (1) helping marketing teams understand how to position a brand and/or product, (2) ensuring everyone on a marketing team is aligned in how they portray the brand and/or product, (3) informing marketing design and messaging, (4) informing decisions on packaging and distribution, and (5) providing insight into what are the correct marketing channels with respect to a brand/product.

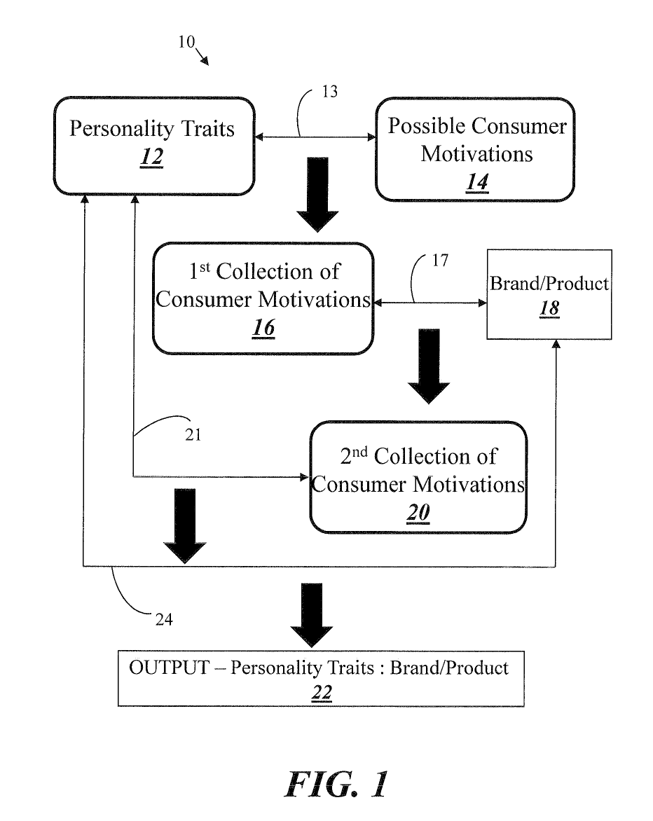

FIGS. 1 through 4, wherein like parts are designated by like reference numerals throughout, illustrate an example embodiment of a system and method for determining correlations between personality traits of a group of consumers and one or more brand/product according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as order of steps, combination or division of one or more steps, inclusion of more or less modules, implementation in different computing environments or systems, and the like, all in a manner still in keeping with the spirit and scope of the present invention.

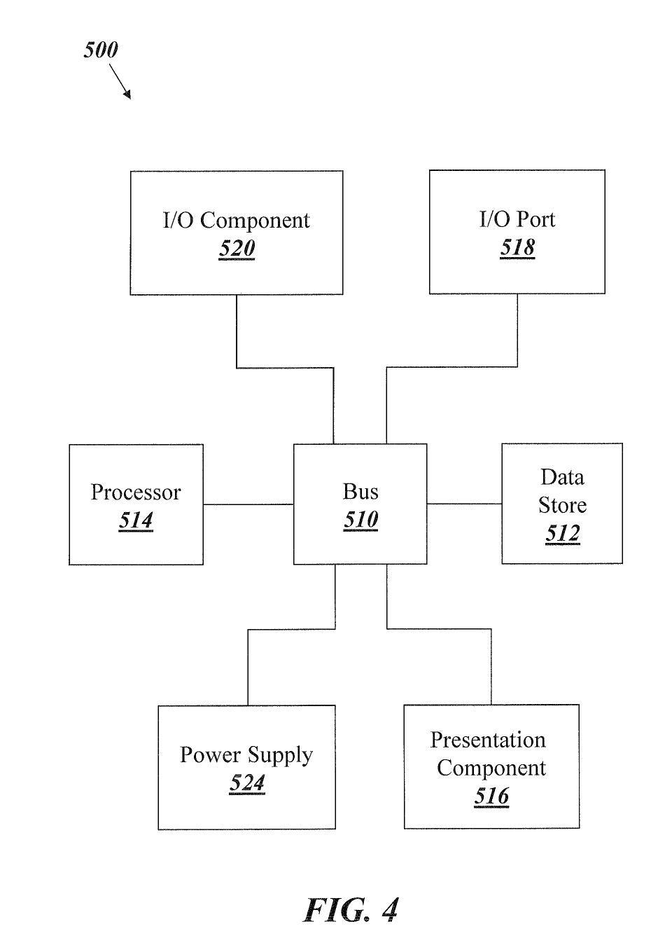

FIG. 1 depicts an example system 10 for determining correlations between personality traits of a group of consumers and one or more brand/product. The system 10 can be implemented, e.g., by a computing device such as the example computing device 500 depicted in FIG. 4 (for example, implemented on one or more server devices), as described in further detail herein. For example, the various parts of this system 10 can be implemented as instructions contained in one or more non-transitory computer readable media and/or computer storage devices.

In one example, the system 10 can include at least one data store 512, at least one processor 514, and at least one output device (e.g., input/output components 520 or presentation component 516) as shown in FIG. 4. One or more personality traits 12 for a group of consumers can be stored in the at least one data store 512 of the system 10. These personality traits 12 can be provided from responses to surveys within the system 10. Alternatively, the personality traits 12 of the group of consumers can originate from a source outside of the system 10 (e.g., external survey data). Using at least one processor 514, associations 13 between possible consumer motivations 14 and the stored one or more personality traits 12 are determined. A first collection of consumer motivations 16 results from the associations 13 between possible consumer motivations 14 and the personality traits 12. This first collection of consumer motivations 16, derived from the possible consumer motivations 14, is stored in at least one data store 512.

Using at least one processor 514, a correlation 17 is determined between the first collection of consumer motivations 16 and one or more brand/product 18. This correlation 17 is used to derive a second collection of consumer motivations 20 from the first collection of consumer motivations 16. The second collection of consumer motivations 20, based on the correlation 17 between the first collection of consumer motivations 16 and the brand/product 18, is stored in at least one data store 512.

Using at least one processor 514, a correlation 21 is determined between the previously stored personality traits 12 and the second collection of consumer motivations 20. This correlation 21 is being performed to identify which of the one or more personality traits 12 contributed to each of the consumer motivations of the second collection of consumer motivations 20. The correlation 21 between the personality traits 12 and second collection of consumer motivations 20 is used to derive a correlation 24 between the personality traits 12 of the group of consumers and the one or more brand/product 18. This correlation 24 is outputted, using an output device (e.g., input/output components 520 or presentation component 516), as a result 22 (e.g., displayed as a graph) describing the correlations between the one or more personality traits 12 of the group of consumers and the one or more brand/product 18.

### Motivational Assessment

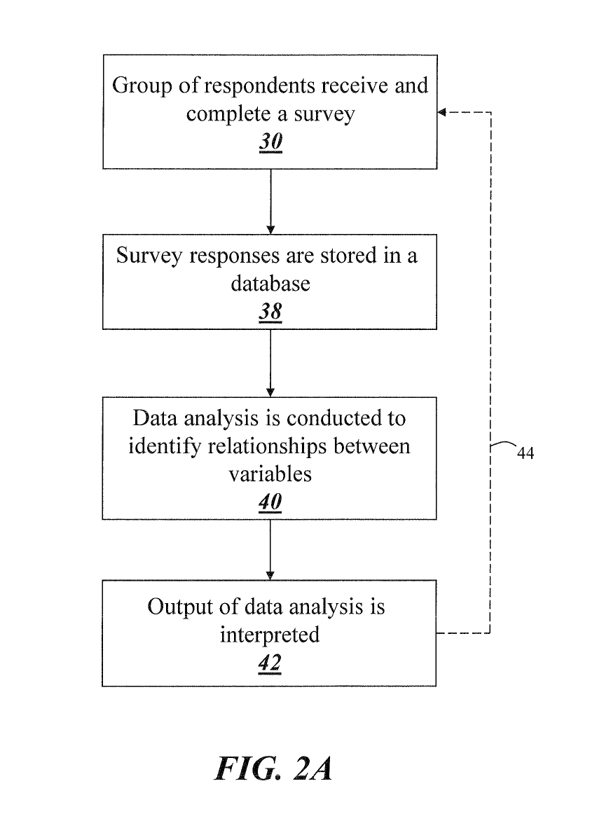

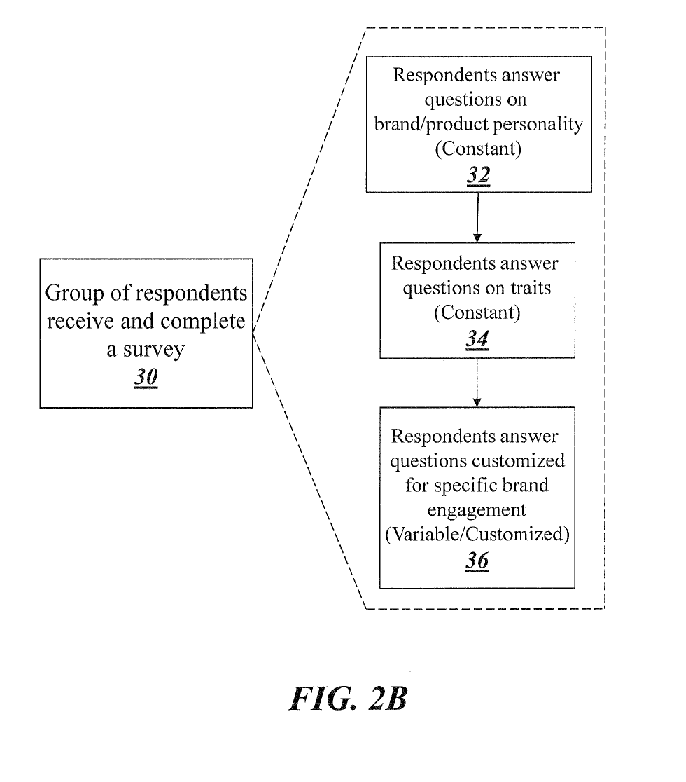

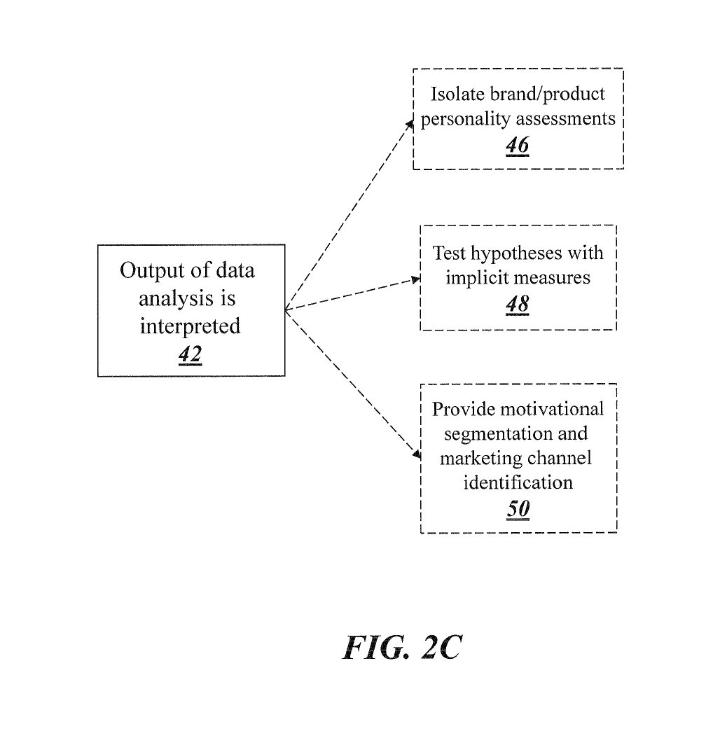

FIG. 2A depicts an example method by which the system 10 can determine the outputted result 22 of correlations 24 between personality traits 12 of a group of consumers and one or more brand/product 18. In this example, the consumers are referred to as respondents since they are responding to surveys related to determining the correlations 24 between personality traits 12 and one or more brand/product 18.

The system 10 using the method in FIG. 2A can establish the motivations that drive consumer behavior allowing a user to ascertain which motivations are relevant or irrelevant. By relying on datasets from a group of consumers with known personality traits 12, the system 10 enables a user to understand what motivations are behind any aspect of consumer behavior (e.g., what elements of the brand/product 18 are important to whom and why).

In this example, a group or set of respondents (i.e. consumers) are provided a survey which the respondents complete (step 30). The completion of the survey (step 30) can include three sub-steps as shown in FIG. 2B. These three sub-steps can be completed in any order. In step 32, respondents answer questions on brand/product 18 personality. In step 34, respondents answer questions that are used to calculate trait scores (i.e., personality traits 12). In step 36, respondents answer questions customized for a specific brand engagement (i.e., related to brand/product 18). In this example, the survey questions of steps 32 and 34 are typically standardized or constant, while the survey questions of step 36 are variable/customizable based on a particular brand/product 18. In particular, the scores from steps 32 and 34 (e.g., related to respondent's personality traits and brand/product personality traits) are actually aggregations across questions (e.g., a score for a given trait is the sum of a known number of questions that comprise the scale for that trait).

In one particular example, the survey can be a trait survey that has questions related to one or more of: brand, product, and domain of interest. The trait survey is used to identify one or more personality traits 12 for a group of respondents such as consumers. Here, respondents answer survey questions that assess their personality traits, and then they answer a series of questions related to a brand, product, or domain of interest.

In another particular example, step 36 can include a respondent (i.e., consumer) answering a series of questions related to a brand/product 18. These questions are different for every brand/product 18 and are tailored to the brand/product 18. For example, purchasing decisions are broken into component pieces, and questions are created for each component piece as part of a survey. In a local dairy farm survey example, respondents were asked to rate on a scale of 1-7 how much they considered a number of different attributes when purchasing milk (e.g., freshness, appearance, whether it's organic, whether cows are treated with hormones, etc.). In other examples, respondents are asked questions related to how much they like certain products, how often they purchase the products, what they like about the products, and essentially anything related to a specific brand, product, or the individual's general consumer behavior.

As discussed above, the system 10 stores one or more personality traits 12 (as determined from surveys) for a group of consumers in at least one data store 512. In the FIG. 2A example, the personality traits 12 are determined by the survey provided and completed in step 30. These personality traits 12 (i.e., determined based on survey responses) are stored in at least one data store 512, more particularly a database (step 38). In step 38, the survey responses are stored in a database (i.e., data store 512) and organized by a respondent or consumer identification (ID) such as an ID # with respect to a survey item (e.g., as a table—the ID # is a particular row # and the survey item is a particular column #).

In step 40, data analysis is conducted to identify relationships between variables. In general, statistical analysis is conducted to identify correlations and other indices of statistical relationships between personality traits and all other survey items. More particularly, step 40 includes using at least one processor 514 to determine a first collection of consumer motivations 16 of the group of consumers based on associations 13 between possible consumer motivations 14 and the personality traits 12 from the group of consumers.

Step 40 further includes using at least one processor 514 to derive a second collection of consumer motivations 20 from the first collection of consumer motivations 16. Each consumer motivation of the second collection of consumer motivations 20 has a correlation 17 with a brand/product 18 used as the subject for step 36. In particular, the second collection of consumer motivations 20 connects all relevant motivations to specific aspects of the brand/product 18 they connect to most strongly (e.g., which motivations are related to packaging as opposed to the product itself). This is important because explicit self-reports about consumer's motivations behind their choices and behaviors are notoriously unreliable, and extracting the consumer motivations out of a dataset by incorporating the consumer's psychological profiles allows a user of this system 10 to circumvent self-reported motivations. In other words, this second collection of consumer motivations 20 provides a reliable portal into the motivations behind consumer behaviors that the consumer may not be aware of, or be able to consciously identify. Furthermore, it allows a user of the system 10 to test any motivation, regardless of whether anyone ever reports such motivation, and allows a user to rule out motivations that seem likely, but are actually irrelevant.

Correlations 24 between the personality traits 12 and the one or more brand/product 18 are determined by identifying which of the one or more personality traits 12 contributed to each of the consumer motivations of the second collection of consumer motivations 20 (i.e., correlation 21 between personality traits 12 and second collection of consumer motivations 20). More particularly, data is analyzed in step 40 using statistical software (Excel, Statistical Product and Service Solutions (SPSS), etc.) to uncover connections between answers to survey questions and respondents' or consumers' psychological profiles (based on personality traits 12) in accordance with numerous methodologies that are readily apparent to those of skill in the art. For example, in the survey for local small-batch milk, it was found that levels of eco-consciousness (a personality trait 12) correlated with how much people take into account whether milk is organic (a brand/product 18) when making their purchase. This can be interpreted as eco-consciousness being a motivation for purchasing organic milk (or at least some purchases of organic milk are motivated by high levels of eco-consciousness). Analyzing the connections in aggregate datasets between consumer's personality traits 12 and consumer's behavior (with respect to a brand/product 18) to understand consumer's motivations without the consumer having to actually report such motivations is especially important to the operation of the system 10.

In one illustrative implementation of step 40, a series of scores are determined using at least one processor 514. The series of scores form a profile for each of the one or more personality traits 12 for each consumer or respondent based on survey answers to surveys completed by each consumer or respondent. In a further example, at least one processor 514 is used to determine a psychological profile based on these series of scores. Additionally, at least one processor 514 can be used to determine connections between the psychological profile and the series of scores for each consumer or respondent. For example, each of the surveys can begin with a series of trait questionnaires, either taken from psychology literature, or developed separately, which result in a series of scores for each respondent or consumer on each personality trait (e.g., someone would answer questions translatable to an extraversion scale and then receive a score between 20-50, answer questions translatable to an eco-consciousness scale and receive a score between 30-40, etc. where each score indicates how high they are on each personality trait). This series of trait scores can be referred to as a respondent's psychological profile, and can be interpreted as how strongly they harbor the motivation(s) associated with each personality trait 12. Psychological trait scales with sufficient validity and reliability are used to develop the psychological profiles.

Personality traits 12 can be used to understand what the active motivations are across a group of consumers that lead to purchasing decisions, for example. This is an approach that focuses on the link between consumers and brands/products 18, rather than focusing solely on consumers. This process is based on analyzing the interactions between consumers and a brand/product 18, and thus any segments that result would be brand/product-specific, and may change over time as consumer motivations and brand image and product offerings change.

Using personality traits 12 to access and understand consumer motivations has at least three primary applications: (1) Using aggregate trait data (i.e., data that incorporates psychological profiles from many individuals) to understand the motivations behind consumer behavior; (2) Combining personality traits together (interactions of personality traits), and combining personality traits with other confirmational research (such as an Implicit Association Test (IAT)) to understand the specific nature of consumer motivations; and (3) Constructing combinations of continuous personality traits based on consumer-brand/product interactions (rather than creating universal personality types) for one-of-a-kind segmentation and understanding.

In particular, step 40 involves analyzing connections between people's personality traits, and different aspects of consumer behavior and preferences. Personality traits (e.g., extraversion, conscientiousness, need for cognition, etc.) and trait preferences (e.g., eco-consciousness, desire for unique products, etc.) can be conceptualized as chronic motivations. Personality traits are defined as patterns of behaviors and preferences that are relatively stable across the lifespan, and across different situations. Because motivations are the drivers behind behaviors and preferences, personality traits represent motivations that are relatively consistent across many domains of an individual's life. By analyzing a dataset generated by consumers with known profiles, the true motivations behind consumers' decisions can be captured, even when consumers cannot explicitly report such motivations. This is performed, for example, by utilizing statistics to determine which personality traits predict brand/product affiliation, as well as which personality traits predict different components of a brand/product image (e.g., separate components that contribute to brand/product image, such as marketing messages, product features or packaging, etc.).

The correlations between the one or more personality traits 12 of the group of respondents (i.e. consumers) and the one or more brand/product 18 are outputted, using an output device (e.g., input/output components 520 or presentation component 516), as a result 22 in step 42. Step 42 includes interpreting output of data analysis. In particular, step 42 involves interpretation of an output of statistical analysis (e.g., using at least one processor 514). The correlations 17, 21, 24 and associations 13 are determined using statistical relationships such as between the personality traits 12 and other survey questions related to one or more brand/product 18. In particular, these statistical relationships can represent a motivational alignment between a personality trait 12 and the subject of the question it is related to such as a specific brand/product 18. Step 42 may also include analogous interpretations of other statistical relationships. For example, a correlation between a particular brand/product personality trait (determined from step 32) and one of the questions on the customized survey in step 36 might indicate that the subject of the question (i.e., specific brand/product engagement) in step 36 contributes to the brand/product being seen as having that particular brand/product personality trait.

### Confirmatory Analysis

Step 44, shown as a dotted line in FIG. 2A, is an optional step that is applied depending on the circumstance. In general, step 44 is an analysis of the interactions of multiple personality traits 12, rather than a simple assessment of the main effects of individual personality traits 12. By combining motivations, the specific driving forces behind people's decisions can not only be confirmed, but can also be better understood. In step 44, the process of steps 30-42 are repeated as necessary to answer new questions, confirm a finding or result, or refine understanding of identified motivational alignments. In particular, the deriving of the second collection of consumer motivations 20 may be optimized and repeated for identifying additional consumer motivations in step 44. Alternatively or additionally, the second collection of consumer motivations 20 may be refined (e.g., using at least one processor 514) in step 44. Step 44 can also include identifying (e.g., using at least one processor 514) a specific understanding of the nature of the derived second collection of consumer motivations 20.

In general, step 44 is used as an exploratory-confirmatory continuum to learn more about specific motivations determined from steps 40 and 42, and how they apply to a specific brand/product. Step 44 can involve any number of additional surveys that incorporate psychological profiles, with each iteration answering different questions, and refining a user's understanding of the motivational alignments.

For example, a first survey used in step 30 may generally include fairly broad brand/product 18 based questions, and all possible personality traits 12 that may be relevant motivations. After this first survey, the important motivations are determined in steps 40 and 42, but there are further questions about how specifically such motivations apply. Further, additional surveys are provided in step 44 to hone in on what exactly the connections are, and the specific nature of each motivation. Often in doing so, new relevant personality traits may be discovered and incorporated. For example, step 44 may include a survey that is meant to be confirmatory where respondents answer very specific questions that resulted from the earlier surveys. However, it is possible that responses to this confirmatory survey may result in new relevant personality traits not discovered in the earlier surveys.

In step 44, a more targeted approach is taken to confirm the results from step 42, and further elaborate and specify relevant connections. Once the right motivations are established, step 44 can include further surveys presented to respondents (i.e. consumers) for targeting specific components related to a brand/product 18, such as detailed packaging assessments.

For example, steps 40/42 may reveal that one of the relevant motivations driving consumers to a specific brand/product 18 is a desire for unique things. However, this does not specify whether someone has an inherent desire for unique products, regardless of whether others know about their purchases (i.e., an intrinsic motivation), or whether someone likes to buy unique products to show them off to others (i.e., an extrinsic motivation). The nature of the motivation can be clarified, in step 44, by adding in measures of public consciousness (how alert one is to his or her self-image). By analyzing both personality traits 12 together (using statistical techniques such as correlation and multiple regression), the nature of the motivation can be better understood (e.g., whether the motivation is intrinsic or extrinsic).

In one example, an additional part of step 44 is the creation of surveys for brand's own customers that enable linking findings to the actual customer profiles and motivations of a brand's existing customers. This may or may not include psychological profiles of a brand's customers, but generally includes a series of survey questions that can link this brand group of consumers to the group of consumers assessed by the system 10. This is done to confirm the validity of the findings from earlier in the process and/or identify meaningful differences in the motivations discovered and those of existing brand customers, allowing a user to suggest potential new avenues for customer acquisition, for example.

FIG. 2C illustrates optional add-on steps that may be added to step 42 of FIG. 2A as designated by the dashed arrows and labeled accordingly. These additional steps relate to analysis of brand/product personality, implicit cognition measures, and marketing channels.

### Brand/Product Personality

In step 46, brand/product personality is optionally added and assessed. For example, a desired brand/product personality is identified (e.g., using at least one processor 514). In particular, one or more consumer motivations of the second collection of consumer motivations 20 are identified (e.g., using at least one processor 514) as actually positively correlating with the desired brand/product personality.

There are a number of assessments for step 46 focusing solely on brand/product personality that can be performed. The assessments include: (1) Creating a striving index from the difference between actual and ideal brand/product personality (as reported by brand representatives for example); (2) Assessing ideal brand/product personality from potential consumers, and capturing areas for improvement with actual brand/product personality as perceived by consumers; (3) Using brand/product personality traits, brand/product characteristics, or combinations thereof as a tool to align different individuals on a marketing team (i.e., finding inconsistencies in the reports of different members of a marketing team); and (4) Using brand/product personality traits, brand/product characteristics, or combinations thereof as a diagnostic tool to understand how various aspects of a brand/product, and different consumer-facing components are perceived by consumers, and using this information to determine which consumer-facing components might be out of alignment, or could use improvement. Step 46 can be used for identifying misalignments between brand/product personality as reported by different brand representatives and alignments (or misalignments) between how brand representatives think they're perceived and how people actually perceive the brand/product. Also, step 46 can be used to assess how different marketing materials or brand/product features are assessed in terms of brand/product personality.

Step 46 is necessary for a comprehensive understanding of brand/product image. It reveals how a brand is trying to position itself, whether it is successful in these efforts, and whether the marketing team behind a brand is well coordinated. Furthermore, it helps to establish how consumers see a brand/product and various marketing materials (i.e., whether the brand/product is positioned as intended), what consumers' ideal brand/product image would be, what specific aspects of brand/product image motivate consumer behavior, and how brand/product image aligns with consumer motivations.

One part of step 46 may require identification (e.g., using at least one processor 514) of one or more brand/product personality traits, brand/product characteristics, or combinations thereof. This step involves analyzing brand/product personality from a number of different perspectives. Brand/product personality consists of the person-like characteristics that people attribute to a brand/product, and can be an important element of brand/product image. People are often drawn to a brand/product because they want to display the brand/product personality traits, for example, many people may buy certain expensive cars because they want to be seen as sophisticated, a trait that can be associated with specific car brands.

Assessing brand/product personality enables one to uncover the alignments between individuals and brand/product image that motivate purchasing behavior. In a further example, assessing brand/product personality is used to identify optimal brand/product image to inform brand/product positioning, and can also be used to see whether all members of a marketing team or company are aligned in how they see the brand/product and try to portray that brand/product.

The identification of the brand/product personality traits, brand/product characteristics, or combinations thereof may include providing a brand/product survey having questions related to dimensions of the brand/product personality traits, brand/product characteristics, or combinations thereof. For example, a brand/product personality questionnaire that taps into dimensions of brand/product personality traits is given to respondents such as marketers, company representatives, or consumers.

In another example of step 46, the identification of the brand/product personality traits, brand/product characteristics, or combinations thereof further includes using at least one processor 514 to determine a brand/product personality striving index. The brand/product personality striving index is determined based on response data from surveys directed to a respondent perceived brand/product market position and a respondent ideal brand/product market position. Also, identification of the brand/product personality traits, brand/product characteristics, or combinations thereof includes assessing (e.g., using at least one processor 514) the respondent ideal brand/product market position for potential consumers. Alternatively, identification of the brand/product personality traits, brand/product characteristics, or combinations thereof includes capturing (e.g., using at least one processor 514) areas of improvement based on the respondent perceived brand/product market position.

For example, brand/product personality surveys are given to respondents. These are given in a number of different versions, where each version has a different prompt. For example, respondents are asked to answer the same brand/product personality questionnaire in two forms: (1) How they see the brand/product at present (respondent perceived brand/product market position), and (2) What they believe should be the ideal brand/product positioning (respondent ideal brand/product market position). Responses to both surveys are analyzed to understand how respondents such as people in a company see brand/product(s) (perceived), how aligned they are in what they report, and what they think their brand's image should be (ideal). These responses are combined to create a brand/product personality striving index.

Creating the brand/product personality striving index from differences between actual (perceived) and ideal brand/product personality is an important implementation. In one example, the brand/product personality striving index represents the areas in which company personnel see room for improvement in their branding and marketing efforts (i.e., any aspect in which the ideal is different than the actual assessment represents areas the brand/product is striving to change or improve).

In one example, if a brand/product is well-known, respondents may simply be asked to complete the brand/product personality questionnaire for the brand/product and potential competitors (i.e., the prompt would be: “Rate Brand X on the following characteristics”). In particular, respondents are given various marketing materials (e.g., for the prompt they might be asked to look over the company's website or social networking page, given a company brochure, shown one of the company's ads, etc.) and then asked to complete the brand/product personality questionnaire based on what they have recently seen. Alternatively, the prompt asks respondents to imagine their ideal brand/product before completing the brand/product personality questionnaire. However, any variation of prompt could be given to understand different aspects of brand/product personality (e.g., asking what differentiates two brands with a prompt such as: “Please rate how much you think Brand X is greater than or less than Brand Y on the following characteristics”). In many of these applications, typically consumers are asked to rate the brand/product personality of familiar brands, and are not asked to assess brand/product personality of marketing materials, ideal brand/product personality, etc.

In other examples, additional survey questions are added to these brand/product personality surveys to understand how different elements of a brand/product's perceived personality affect consumer decisions. For example, respondents answer survey questions to assess their own personality traits 12 (allowing a user of the system 100 to connect people's personalities to how they see a brand/product's personality), or respondents are asked how interested they would be in a brand/product, or how often they buy a brand/product, to understand what brand/product characteristics are most important in people's purchasing decisions. Insights and answers to research questions are attained from these surveys through statistical analysis of the data. Adding such components to brand/product personality questionnaires is used to gain further insights into the impact of brand/product personality on consumer decisions.

### Implicit Cognition Measures

In optional step 48, a confirmatory implicit measurement is determined. Step 48 tests hypotheses with implicit cognition measures. In particular, the hypotheses generated in earlier analyses steps may be tested using implicit association measures such as Implicit Association Tests (IAT), Go-No-Go tasks, Dot-Probe tasks, priming tasks etc.

The confirmatory analysis of step 48 is used to uncover consumer preferences and associations and to confirm consumer motivations derived from exploratory research of steps 40 and 42. Step 48 is important for confirming relevant findings. Some findings may suggest important hypotheses and concomitant predictions that should be tested to make sure a user correctly understands the results of the earlier steps. For example, determination of the first collection of consumer motivations 16 may further include using at least one processor 514 to determine implicit cognition measures for each consumer of a group of consumers based on survey answers to surveys completed by each consumer.

In one example, surveys with psychological profiles may lead one to believe that consumers simply see milk in a glass as being higher quality than milk in plastic or cartons, but these surveys could not confirm this to be the case. Thus, a user may implement the glass vs plastic/high quality vs. low quality IAT to confirm this interpretation of the data. In other words, multiple interpretations are always possible from a given finding or set of findings, thus this step can optionally be used to hone in on the most likely interpretation by probing unconscious associations directly, rather than inferring them from relationships between psychological profile data (personality traits 12) and brand/product relevant questions 18.

The IAT is an example of a reaction-time-based task in which people quickly categorize words or images into two binary categories (with 4 possible categories total, as explained below). In particular, reaction-time-based implicit cognition measures can be implemented with software that can accurately measure reaction time.

In one example, the determination of the first collection of consumer motivations 16 further includes providing an implicit cognition survey having questions related to one or more of: implicit associations, biases, and motivations. For example step 48 can include a battery of implicit cognition measures used to assess implicit associations, biases, and motivations. These measures are all tools that allow one to measure unconscious associations that consumers may or may not be aware of. Unconscious associations are psychological associations that people have between two concepts that they are not aware of. These can differ from conscious associations or may be the same, but importantly the unconscious associations result from different psychological processes, which is why these special techniques can be used to access them.

Many of the tasks that have been developed to assess unconscious associations were originally designed to measure implicit prejudiced attitudes, such as negative attitudes towards minorities. However, these tests may be used to uncover associations relevant to consumer behavior, as outlined below. The dependent variables in all of these tasks are based on either some measure of reaction time to various kinds of categorization tasks, or are based on measuring ease of recall of words or concepts.

Implicit cognition measures that rely on measuring and comparing reaction times include: (1) the Go-No-Go task, which is basically an IAT with only one category; (2) Onset Asynchrony tasks, in which the categorical stimuli are presented over time, rather than over space; and (3) the Dot-Probe task, which is similar to an IAT with stimuli that combine both time and space.

Another class of implicit cognition measures includes tasks that are based on ease of recall, such as the Word Completion task. These kinds of tasks are based on the well-established finding that when two things are associated, priming of one of them, will make the other category more easily accessible, leading people to be more likely to recall such a word on such ambiguous tasks. Other tasks like this include Sentence Completion tasks, similar to the Word Completion task, but with words missing from sentences, rather than letters from words, and Recall Bias tasks, in which people are given ambiguous stories, and asked what they recall after.

All of the implicit cognition measures allow us to probe associations and motivations people have that they are not necessarily aware of. For example, with the local dairy farm example, findings seemed to indicate that consumers were simply associating the glass bottles the milk was packaged in with quality (at least when compared to plastic jugs or cartons). In this example, if they were more eco-conscious, they were more likely to report milk in a glass bottle as eco-friendly, suggesting that it was an implicit association with quality, that they then translated into whatever they associated with quality. To test this hypothesis, an IAT may be created using a “Glass” vs. “Plastic” binary category that used pictures of milk in glass or plastic bottles, and a “High Quality” vs. “Low Quality” binary category that used words denoting high or low quality such as “Excellent” or “Disgusting”, respectively. Consumers were much faster at making correct categorizations when “Glass” and “High Quality” were paired up than when “Glass” and “Low Quality” were paired up, confirming the hypothesis. This is an example of how these tests are used in a confirmatory manner (i.e., “confirming” a hypothesis generated from earlier “exploratory” research).

### Motivational Segmentation and Marketing Channel Identification

Optional step 50 is used for providing motivational segmentation and marketing channel identification. Step 50 can be exploratory in nature. In one example, step 50 includes identifying (e.g., using at least one processor 514) which of the consumer motivations of the second collection of consumer motivations 20 correlate to each of the marketing channels. In a further example, the identification of consumer motivations that correlate to marketing channels further includes providing a marketing channel identification survey to the group of consumers having questions related to participation in marketing channels. Alternatively, the identification of consumer motivations that correlate to marketing channels further includes using at least one processor 514 to determine marketing channel identification data for each consumer of the group of consumers based on survey answers to surveys completed by each consumer.

Step 50 allows a user to identify consumer motivational segments (e.g., using at least one processor 514) and where to find them, so that one can advise a brand on where they should focus their efforts to find consumers with the motivations identified in previous steps of this process. In one particular example, consumer motivational segments are generated based on the one or more consumer motivations of the second collection of consumer motivations 20. Such consumer motivational segments are useful in determining how advertisements and other communications should be targeted. Traditionally, segmentation has relied most heavily on demographic information (i.e., age, income, ethnicity, geographic location, etc.). The consumer motivational segments can give a brand insight into where and how they can target the right consumers with the right motivations. In one example, motivational segments can be created by extracting motivational clusters from previous steps of system 10 (i.e., identifying groups of traits that correlate with each other, but not with traits in another cluster).

Step 50 includes surveys being given to people with known psychological profiles and asks them about their engagement and/or participation in various different marketing channels. For example, a brand may wish to know which magazine(s) they should advertise in to reach people that have the motivations associated with their brand/product 18 that were identified in previous steps. This could be done by having people with known psychological profiles (based on personality traits 12) answer surveys about what magazines they read, subscribe to, are interested in, etc. With such a survey, a respondent would start by answering questions on the personality trait scales (or at least the personality traits 12 associated with the motivations relevant to the brand/product 18), and then answering questions about their magazine reading habits. This data is analyzed statistically to determine which magazines are read by people with the right motivational profiles. This is not limited to magazines; as such an approach could also be used for TV shows or websites, etc. For example, motivational profiles can be determined with respect to various marketing channels by surveying the traits of consumers that are present in the different marketing channels (e.g., creating or generating trait profiles for various TV shows allows for identification of which traits correspond to one TV show versus another TV show).

### Application

The process in FIGS. 2A-2C is customizable which evolves as data comes in (e.g., if an unexpected finding occurs in a first survey from step 30, a user may add in questions related to additional personality traits 12, focus on different aspects than planned, or provide new or different questions). In other words, the steps explained above may be employed in a flexible process, a process in which these components are mixed and matched and customized based upon the desires of a user or situation, and questions or hypotheses that result from one step of the process informing another step of the process.

This process could be used to assess consumer motivations for all kinds of things, depending how each component or step is designed. As noted throughout, some of these research tools/approaches were originally designed for different purposes, and have been adapted and combined into this process. In principle, this process could be used to determine consumer motivations for other reasons all within the scope of the present invention.

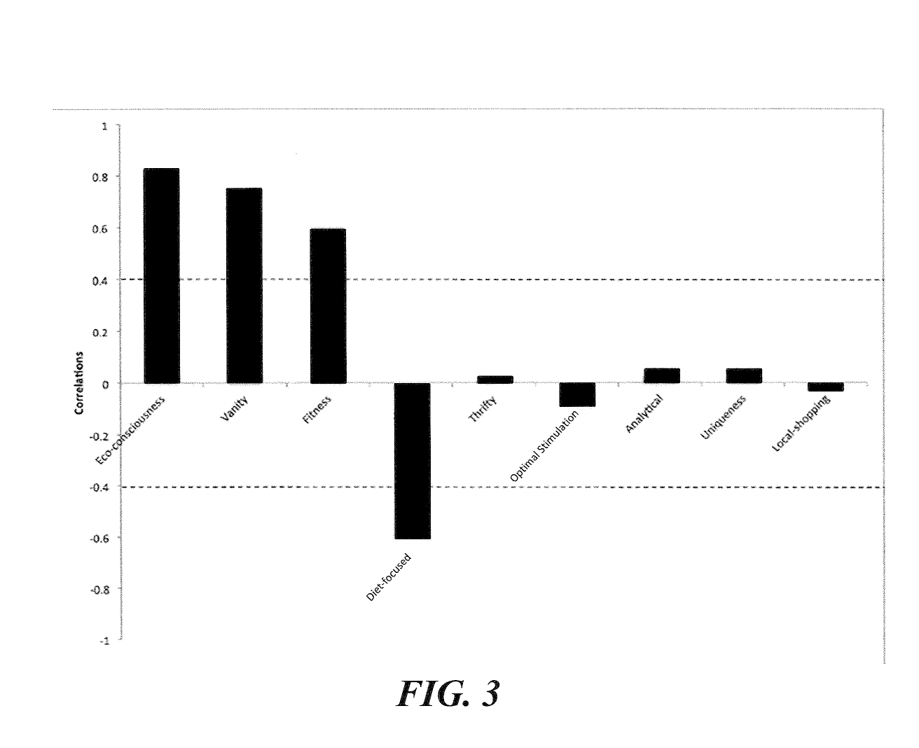

FIG. 3 is a bar graph illustrating a visual representation of the data output from step 42 in FIG. 2A. Each of the words listed along the x-axis represent personality traits 12 (derived from trait scales). In this example, the personality traits 12 are eco-consciousness, vanity, fitness, diet-focused, thrifty, optimal stimulation, analytical, uniqueness, and local-shopping. The y-axis represents the correlation between the trait scores (personality traits 12) and the output of some question (e.g., “How often do you consume whey-based protein powder?” in which respondents answer on a 1-7 scale where 1 is “never” is 7 is “all the time”) related to a brand/product 18 (protein powder). The dashed lines at +0.4 and −0.4 represent the statistical thresholds for considering a personality trait 12 as aligned with frequency of protein powder consumption (so a correlation of −0.4<r<0.4 would not be considered a relevant motivation). FIG. 3 depicts the personality traits 12 of eco-consciousness, vanity, and fitness as positively correlated with protein powder consumption (e.g., people consume protein powder because they are vain, into fitness, and/or eco-conscious), and that the personality trait 12 to maintain a healthy diet (diet-focused) is negatively correlated with protein powder consumption (e.g., people who are motivated by maintaining a healthy diet avoid consuming protein powder; this means that diet-focused is a motivation not to consume). The other personality traits 12 of thrifty, optimal stimulation, analytical, uniqueness, and local-shopping have no relationship with protein powder consumption due to these personality trait correlations failing within the range −0.4<r<0.4. These personality traits 12 (thrifty, optimal stimulation, analytical, uniqueness, and local-shopping) are interpreted as being irrelevant in this context (i.e., whether to buy and consume protein powder). Therefore, these personality traits 12 neither show a positive correlation nor negative correlation with protein powder consumption (brand/product 18).

FIG. 4 illustrates an example of a computing device 500 for implementing aspects of the illustrative methods and systems of the present invention. The computing device 500 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a data store (e.g., memory) 512, one or more processors 514, one or more presentation components 516, input/output ports 518, input/output components 520, and a power supply 524. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The at least one data store 512 can include computer-storage media in the form of volatile and/or nonvolatile memory. The at least one data store 512 can be removable, non-removable, or any combination thereof.

Exemplary hardware devices are devices such as hard drives, solid-state memory, optical-disc drives, and the like.

The computing device 500 can include one or more processors 514 that read data from components such as the at least one data store 512, the various I/O components 520, etc.

Presentation component(s) 516 present data indications to a user or other device. Exemplary presentation components 516 include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, blue-tooth device, networking device, and the like.

One of skill in the art will appreciate a wide variety of ways to modify and alter the system and method of FIGS. 1-2B, as well as the various components with which it interacts. For example, the one or more computing systems can be implemented according to any number of suitable computing system structures. Furthermore, some or all of the information contained in the one or more data sources alternatively can be stored in one or more remote databases (e.g., cloud databases, virtual databases, and any other remote database).

In some embodiments, it may be desirable to implement the method and system using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

It is also to be understood that the following claims are to cover all generic and specific features of the invention described herein, and all statements of the scope of the invention which, as a matter of language, might be said to fall therebetween.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer implemented method for determining correlations between personality traits of a group of consumers and one or more brand/product, the method comprising:
storing one or more personality traits for the group of consumers in at least one data store;
determining, using at least one processor, a first collection of consumer motivations of the group of consumers based on associations between possible consumer motivations and the one or more personality traits from the group of consumers, and storing the first collection of consumer motivations in at least one data store;
deriving, using at least one processor, a second collection of consumer motivations from the first collection of consumer motivations, wherein each consumer motivation of the second collection has a correlation with one or more brand/product, and storing the second collection of consumer motivations in at least one data store;
determining, using at least one processor, correlations between the one or more personality traits of the group of consumers and the one or more brand/product by identifying which of the one or more personality traits contributed to each of the consumer motivations of the second collection of consumer motivations based on the associations between the possible consumer motivations and the one or more personality traits from the group of consumers; and
outputting, using an output device, the correlations between the one or more personality traits of the group of consumers and the one or more brand/product.

2. The method of claim 1, further comprising generating, using at least one processor, a plurality of consumer motivational segments based on the one or more consumer motivations of the second collection.

3. The method of claim 1, further comprising identifying, using at least one processor, a desired brand/product personality.

4. The method of claim 3, further comprising identifying, using at least one processor, which of the one or more consumer motivations of the second collection actually positively correlate with the desired brand/product personality.

5. The method of claim 1, further comprising identifying, using at least one processor, one or more brand/product personality traits, brand/product characteristics, or combinations thereof.

6. The method of claim 5, wherein identifying the one or more brand/product personality traits, brand/product characteristics, or combinations thereof further comprises providing a brand/product survey having questions related to a plurality of dimensions of the one or more brand/product personality traits, brand/product characteristics, or combinations thereof.

7. The method of claim 5, wherein identifying the one or more brand/product personality traits, brand/product characteristics, or combinations thereof further comprises determining, using at least one processor, a brand/product personality striving index.

8. The method of claim 7, wherein the brand/product personality striving index is determined based on response data from surveys directed to a respondent perceived brand/product market position and a respondent ideal brand/product market position.

9. The method of claim 8, wherein identifying the one or more brand/product personality traits, brand/product characteristics, or combinations thereof further comprises assessing, using at least one processor, the respondent ideal brand/product market position for potential consumers.

10. The method of claim 8, wherein identifying the one or more brand/product personality traits, brand/product characteristics, or combinations thereof further comprises capturing, using at least one processor, a plurality of areas of improvement based on the respondent perceived brand/product market position.

11. The method of claim 5, further comprising using the brand/product personality traits, brand/product characteristics, or combinations thereof for aligning different individuals on a marketing team.

12. The method of claim 5, further comprising using the brand/product personality traits, brand/product characteristics, or combinations thereof for determining which consumer-facing components are out of alignment or could use improvement.

13. The method of claim 1, further comprising providing a trait survey having questions related to one or more of: brand, product, and domain of interest, wherein the trait survey identifies the one or more personality traits for the group of consumers.

14. The method of claim 1, further comprising determining, using at least one processor, a series of scores comprising a profile for each of the one or more personality traits for each consumer of the group of consumers based on survey answers to surveys completed by each consumer of the group of consumers.

15. The method of claim 14, further comprising determining, using at least one processor, a psychological profile based on the series of scores.

16. The method of claim 14, further comprising determining, using at least one processor, connections between a psychological profile and the series of scores by each consumer of the group of consumers.

17. The method of claim 1, wherein deriving the second collection of consumer motivations is optimized and repeated for identifying additional consumer motivations.

18. The method of claim 1, further comprising refining, using at least one processor, the second collection of consumer motivations, and identifying, using at least one processor, a specific understanding of the nature of the derived second collection of consumer motivations.

19. The method of claim 1, wherein determining the first collection of consumer motivations further comprises providing an implicit cognition survey having questions related to one or more of: implicit associations, biases, and motivations.

20. The method of claim 1, wherein determining the first collection of consumer motivations further comprises determining, using at least one processor, implicit cognition measures for each consumer of the group of consumers based on survey answers to surveys completed by each consumer of the group of consumers.

21. The method of claim 1, further comprising identifying, using at least one processor, which of the consumer motivations of the second collection of consumer motivations correlate to each of a plurality of marketing channels.

22. The method of claim 21, wherein identifying of consumer motivations that correlate to marketing channels further comprises providing a marketing channel identification survey to the group of consumers having questions related to participation in the plurality of marketing channels.

23. The method of claim 21, wherein identifying of consumer motivations that correlate to marketing channels further comprises determining, using at least one processor, marketing channel identification data for each consumer of the group of consumers based on survey answers to surveys completed by each consumer of the group of consumers.
